(19) United States
(12) Patent Application Publication
(10) Pub. No.: US 2017/0091945 A1
(43) Pub. Date: Mar. 30, 2017

(54) POINT AND SENSOR ESTIMATION FROM IMAGES

(71) Applicant: Ecole Polytechnique Federale de Lausanne (EPFL), Lausanne (CH)

(72) Inventors: MARTIN VETTERLI, Grandvaux (CH); Alireza Ghasemi, Lausanne (CH); Adam Scholefield, Lausanne (CH)

(21) Appl. No.: 15/275,973

(22) Filed: Sep. 26, 2016

Related U.S. Application Data
(60) Provisional application No. 62/232,667, filed on Sep. 25, 2015.

(51) Int. Cl. G06T 7/00; G01C 21/36; B60R 1/00; H04N 7/18; H04N 5/247

(52) U.S. Cl. CPC G06T 7/0044; H04N 7/181; H04N 5/247; B60R 1/00; G01C 21/36; B60R 2300/80

(57) ABSTRACT

System comprising at least one sensor configured to take a set of images from different viewpoints of a scene; a processor configured to identifying a point source represented in the images of a set of images; computing for each image of the set of images the subspace of potential locations of the point source in the scene on the basis of the viewpoint or a viewpoint region of the image and on the basis of the subregion of the image representing the point source; and computing a point intersection region of the subspaces of potential locations of the point source of the images of the set of images.

### REFERENCE DATA

This application claims priority of the provisional patent application U.S. 62/232,667, filed Sep. 25, 2015 the contents whereof are hereby incorporated by reference.

### FIELD OF THE INVENTION

The present invention concerns a system and computer program to estimate location(s) of at least one point and/or pose(s) of at least one sensor.

### DESCRIPTION OF RELATED ART

Camera pose estimation, or the perspective-n-point (PnP) problem, aims to determine the pose (location and orientation) of a camera, given a set of correspondences between 3-D points in space and their projections on the camera sensor. The problem has applications in robotics, odometry, and photogrammetry, where it is known as space resection. In the simplest case, one can use an algebraic closed-form solution to derive the camera pose from a set of minimal 3D-to-2D correspondences. Usually, three correspondences are used and hence these algorithms are called perspective-3-point or P3P methods. When there is a redundant set of points available (more than three), the most straightforward solution is to use robust algorithms, such as RANSAC, which run P3P (or its variants) on minimal subsets of correspondences. However, such algorithms suffer from low accuracy, instability and poor noise-robustness, due to the limited number of points.

An alternative approach is to directly estimate the camera pose, using an objective function, such as the 12 norm of the reprojection error, defined over all available point correspondences. Minimisation of the l2-norm leads to the maximum likelihood estimator, if it is assumed a Gaussian noise model. However, the main drawback of the l2-norm is that its resulting cost function is non-convex and usually has a lot of local minima. Therefore, iterative algorithms are used that are reliant on a good initialisation. The shortcomings of the l2-norm have lead to using other norms, such as the l∞-norm. The main advantage of the l∞-norm is that its minimisation can be formulated as a quasi-convex problem and solved using Second-Order Cone Programming (SOCP). This leads to a unique solution, however SOCP techniques are computationally demanding and rely on the correct tuning of extra parameters.

There is an interesting, well known, duality between pose estimation and triangulation, which allows common algorithms to be used for both problems. Triangulation estimates the location of a point given its projection in a number of calibrated cameras. Various triangulation algorithms exist, which once again mostly relying on minimising the reprojection error. To see the duality, in both cases we have a set of projections and we want to estimate the location of an object of interest; i.e., the camera, in pose estimation, and the point, in triangulation.

Finally, the most difficult problem is to jointly detect the location of the points in a scene and the poses of one or more cameras of different images at different viewpoints. This problem is often called SLAM problem, where SLAM stands for simultaneous localization and mapping. The SLAM problem is also used with similar algorithms as the two problems described before.

### BRIEF SUMMARY OF THE INVENTION

It is an object to find a method to solve those problems faster and with higher quality.

According to the invention, these aims are achieved by means of the independent claims.

The approach to calculate the sub-spaces of potential locations of point(s) and/or of potential sensor pose(s) on the basis of the known information and of the errors and to intersect theses sub-spaces to a point and/or pose intersection region results in a reliable and efficient estimator for the location of point(s) and/or sensor pose(s). Tests showed that this approach outperforms existing methods in reliability and speed.

The dependent claims refer to further advantageous embodiments.

### BRIEF DESCRIPTION OF THE DRAWINGS

The invention will be better understood with the aid of the description of an embodiment given by way of example and illustrated by the figures, in which:

FIG. 1 shows a view of a system according to the invention.

FIG. 2 shows an embodiment of a sensor for taking an image of a scene.

FIG. 3 shows an embodiment of a point source location estimation on the basis of a set of images from different viewpoints.

FIG. 4 shows the point intersection region of an embodiment of a point source location estimation on the basis of a set of images from different viewpoints.

FIG. 5 shows the pose intersection region of an embodiment of a sensor pose estimation on the basis of a set of point sources in an image taken from the sensor.

FIG. 6 shows a first step of an embodiment of a sensor pose and point source location estimation.

FIG. 7 shows a second step of an embodiment of a sensor pose and point source location estimation.

FIG. 8 shows a third step of an embodiment of a sensor pose and point source location estimation.

FIG. 9 shows a fourth step of an embodiment of a sensor pose and point source location estimation.

FIG. 10 shows a fifth step of an embodiment of a sensor pose and point source location estimation.

FIG. 11 shows a sixth step of an embodiment of a sensor pose and point source location estimation.

FIG. 12 shows a seventh step of an embodiment of a sensor pose and point source location estimation.

FIG. 13 shows an eighth step of an embodiment of a sensor pose and point source location estimation.

### DETAILED DESCRIPTION OF POSSIBLE EMBODIMENTS OF THE INVENTION

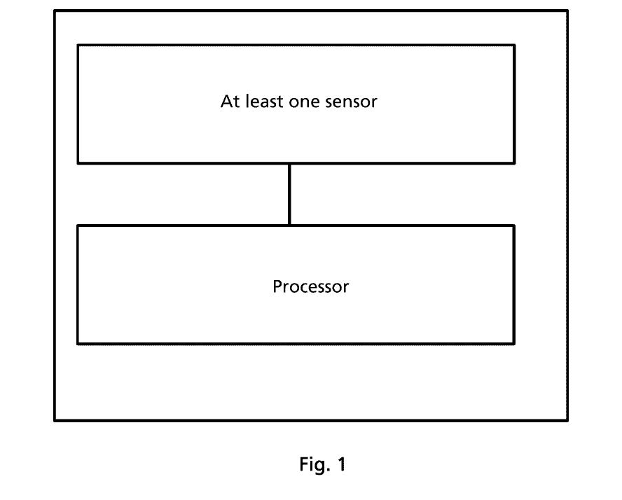

FIG. 1 shows an embodiment of a system comprising at least one sensor and a processor.

The at least one sensor is configured to take at least one image of a scene. Preferably, the sensor comprises a plurality of pixels, wherein each pixel occupies a pixel area on the sensor. Preferably, the sensor is a camera with a camera centre. In one embodiment, the camera is a pinhole camera or can be approximated by a pinhole camera. However, the invention is also possible for fish eye cameras. In one embodiment, the at least one sensor is configured to take a set of images from different viewpoints. This can be realized by moving one sensor to different camera poses and taking the corresponding image of the different viewpoints related to the different sensor poses at different times. However, it is also possible to have different sensors at different sensor poses to take the images from different viewpoints at the same time, like for stereo cameras or camera arrays. Obviously, it is also possible to combine those approaches and take some of the images with different sensors at first poses at a first time and some others of the images with the different sensors at second poses at a second time. A sensor pose is the combination of sensor location and sensor orientation. If in the following a sensor pose is determined, computed or estimated, it is meant that the sensor location and/or the sensor orientation is determined, computed or estimated.

The processor is any means configured to perform the methods described in the following and/or claimed. The processor shall be any means to automatically perform the described/claimed steps. The processor could be a single processor or could also comprise a plurality of interconnected processors. Those interconnected processors could be in a common housing or building or could be remote from each other connected by a network like internet.

For simplicity and ease of visualisation, but without limiting the invention, we will describe the embodiments in a two dimensional space, resulting in one dimensional images; the extension of the idea to a three dimensional space and two dimensional sensors is straightforward and is also part of the invention.

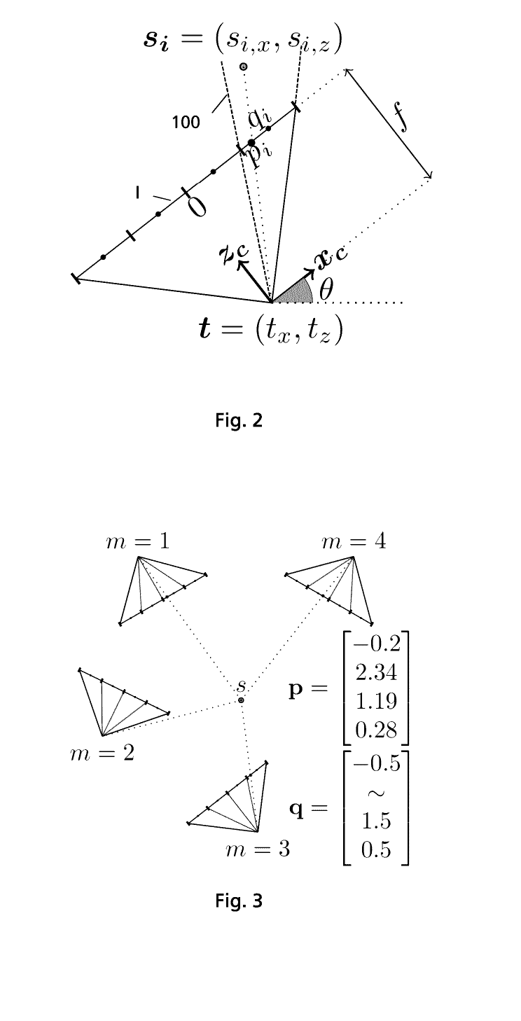

FIG. 2 shows an exemplary pinhole camera as a sensor. The location t=(tx, tz) of the camera centre provides the location of the sensor. The one dimensional camera has a plurality of pixels qi in the image plane I which has a distance of f (focal distance) to the camera centre, here four with i=1, 2, 3, 4. The orientation of the camera is given by the angle θ. In a three dimensional case, the location t=(tx, ty, tz) of the camera and the orientation of the camera θ=(θ1, θ2) must be extend by one dimension and the pixels would have two coordinates qi and qj. A point si=(six,siz) projected on the image plane I has the true position pi on the image plane I. The following equation yields the exact point pi on the image plane

$${p}_{i} = f \frac{( {s}_{i , x} - {t}_{x} ) cos θ + ( {s}_{i , z} - {t}_{z} ) sin θ}{( {s}_{i , z} - {t}_{z} ) cos θ - ( {s}_{i , x} - {t}_{x} ) sin θ} . \qquad ( 1 )$$

If pi would be known, equation (1) would define a line on which the point si must be located. However, due to the area of the pixel in the image plane I, the exact position pi of the point source si cannot be detected. It is known that the exact position pi is somewhere in the subregion related to that pixel qi. In FIG. 1, the subregion related to the pixel qi is the area between the qi−w/2 and qi+w/2, wherein w is the distance between two pixels. In some embodiment, the subregion of the sensor related to the point source si could also cover more than one pixel area. The subspace 100 of potential locations of the point source si could be calculated on the basis of the subregion related to the pixel qi or related to the point source si. In the shown embodiment, the subspace 100 is calculated by the space formed between the hyperplanes going each through one of the pixel boundaries and the camera centre. This subspace 100 can be calculated with the knowledge of the camera parameters, e.g. in the shown FIG. 1 f, t, θ, w, and the knowledge of the pixel qi related to the point source si. In the three dimensional case, the subspace of potential locations of the point source si is the space enclosed by four hyperplanes going each through the camera centre and through one of the four pixel boundaries. Obviously, if the form of the subregion of the sensor/the pixel area hypothetically is not rectangular, other forms of this subspace are possible, e.g. a cone for a round pixel area.

In a first embodiment, a source point s shall be identified localised in a set of images taken from different viewpoints. FIG. 3 shows an exemplary embodiment with four sensor poses m=1, . . . , 4 capturing a scene. The sensors m=1, 3 and 4 captured the point s in the pixel positions −0.5, 1.5 and 0.5. The true position p of the point source s in the four image planes I is unknown. In the following, the steps to determine the location of the point source s from the set of images will be explained.

In a first step, the point source s represented in the images of the set of images is identified as shown e.g. in FIG. 3. As shown in the example, not all images taken from the scene 1 might show the identified point source s so that the images capturing the point source s belong to the set of images of interest. Instead of identifying a point or several points in a set of images, the method could simply receive over an interface the point(s) and their pixel position in the respective images instead of actively identifying the point(s).

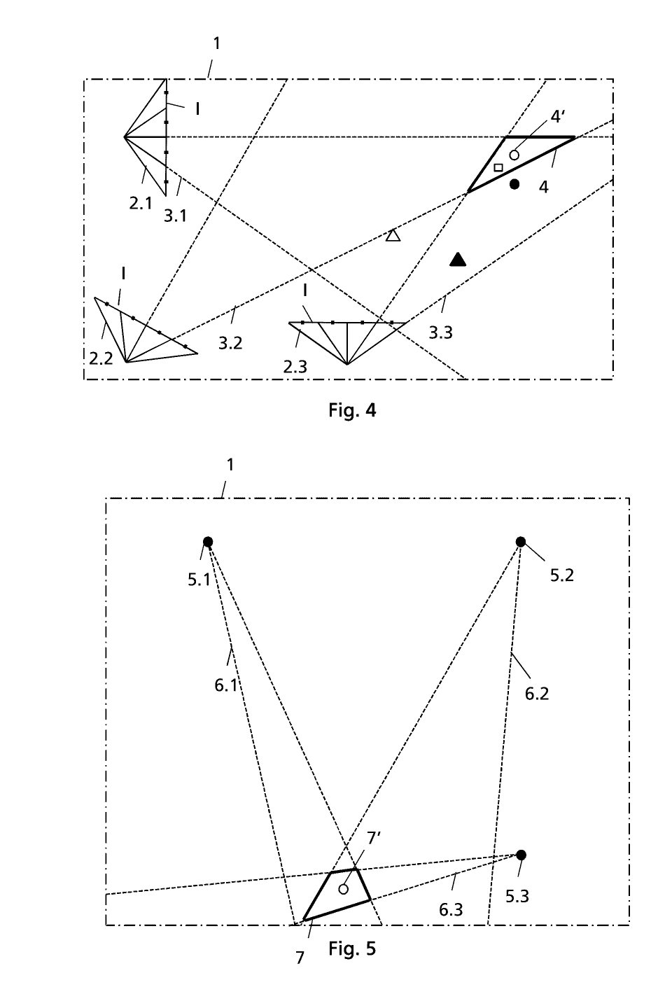

In a second step, for each image of the set of images the sub-space of potential locations of the point source s in the scene is computed on the basis of the viewpoint of the image and on the basis of the sub-region of the image representing the point source. This step is shown in an example in FIG. 4. The scene 1 is represented by three images corresponding to three sensor poses 2.1, 2.2, 2.3 (or viewpoints). The subspace 3.1 of potential locations of the point source s in the scene is computed on the basis of the pixel area representing the point source s in the first image and on the basis of the sensor pose 2.1 as described above. The subspace 3.2 of potential locations of the point source s in the scene is computed on the basis of the pixel area representing the point source s in the second image and on the basis of the sensor pose 2.2 as described above. The subspace 3.3 of potential locations of the point source s in the scene is computed on the basis of the pixel area representing the point source s in the third image and on the basis of the sensor pose 2.3 as described above.

In a third step, a point intersection region of the subspaces of potential locations of the point source s of the images of the set of images is computed by intersecting the mentioned subspaces. In FIG. 4, the point intersection region 4 of the subspaces 3.1, 3.2 and 3.3 is shown in bold. This is the region of potential locations of the point source s on the basis of the three images. The point intersection region 4 could be computed by computing first all subspaces 3.1, 3.2, 3.3 based on all images and then intersecting all subspaces 3.1, 3.2, 3.3 at once. Alternatively, the point intersection region 4 could be computed iteratively by intersecting a new subspace of potential locations of the point source s resulting from a new image showing the point source s with the previously calculated intersection region (the first intersection region would correspond to the subspace of potential locations of the point source s of a first image). The iterative approach is especially advantageous to iteratively improve the localisation image by image. In this way, already after two images, there is a first estimate rough estimate of the location of the point source s which will get better and better with the number of images.

In a fourth step, a point 4′ of the point intersection region 4 is selected as an estimate for the location of the point source s. A good selection algorithm could be the centre of mass of the intersection region 4. However, other selection algorithms could be used to select a point in the point intersection region 4. The intersection region 4 could be proved to be consistent and would yield always a reliable estimate for the point source localisation. FIG. 4 shows also estimates resulting from known estimation algorithms for the point localisation on the basis of the three images. The proposed estimate is as good as the estimate based on the l∞-norm (black empty rectangle) which yields a reliable estimator. The estimate based on the l2-norm (round filled circle), l1-norm (filled triangle) or the linear pseudo inverse (empty triangle) are less reliable estimates of the localisation of the point source s. While the new approach is reliable as the l∞-norm estimator, it provides a faster method to identify the location of a point source on the basis of a plurality of images.

The first embodiment could be either used for multiple sensor/camera systems or for a sensor/camera moving to different viewpoints. Examples of multiple sensor systems are for example linear camera arrays or linear circular camera arrays. The shown algorithm could help to reliably and quickly reveal the point source locations in multiple camera systems. This approach could also be used to perform an adaptive camera tracking. This could be achieved by a multiple camera system, where at least one of the multiple cameras can move its pose (location and/or orientation) in order to optimise (reduce) the point intersection region for a tracked point. When the tracked point changes its location, the movable camera/sensor could adapt its position to maintain the point intersection region optimal/small.

In second embodiment, a number of point sources are known and an unknown sensor pose shall be estimated. FIG. 5 shows an example of a scene 1 with known point sources 5.1, 5.2 and 5.3.

In a first step, sub-regions, e.g. pixels, of the image are identified or received, wherein each sub-region representing a different point source, e.g. point sources 5.1, 5.2 and 5.3.

In a second step, for each point source the sub-space of potential poses of the sensor in the scene is computed on the basis of the location of the point source and on the basis of the sub-region of the image representing the point source. In the following, it is shown how this subspace of potential poses of the sensor can be computed.

Given a quantised projection qi, it is known that the true projected point pi satisfies

$${q}_{i} - \frac{w}{2} \leq {p}_{i} \leq {q}_{i} + \frac{w}{2} . \qquad ( 2 )$$

Combining equation (1) with equation (2) and rearranging results in the equations

$$\begin{matrix}{a}_{i} {t}_{x} + {b}_{i} {t}_{z} + {c}_{i} \geq 0 , \\ and & ( 3 ) \\ {a}_{i}^{′} {t}_{x} + {b}_{i}^{′} {t}_{z} + {c}_{i}^{′} \leq 0. \\ Wherein \\ {a}_{i} = f cos θ - ( {q}_{i} + \frac{w}{2} ) sin θ , \\ {b}_{i} = f sin θ - ( {q}_{i} + \frac{w}{2} ) cos θ , \\ {c}_{i} = ( {q}_{i} + \frac{w}{2} ) ( {s}_{i , z} cos θ + {s}_{i , x} sin θ ) - {fs}_{i , x} cos θ - {fs}_{i , z} sin θ , \\ {a}_{i}^{′} f cos θ - ( {q}_{i} - \frac{w}{2} ) sin θ , \\ {b}_{i}^{′} = f sin θ - ( {q}_{i} - \frac{w}{2} ) cos θ , \\ {c}_{i}^{′} = ( {q}_{i} - \frac{w}{2} ) ( {s}_{i , z} cos θ + {s}_{i , x} sin θ ) - {fs}_{i , x} cos θ - {fs}_{i , z} sin θ . & ( 4 )\end{matrix}$$

Since the point source location (six, siz), the camera parameter like f and the size of the subregion of the sensor w are known, the subspace of potential sensor poses can be computed in the solution space (tx, tz, θ). If we assume that the camera/sensor orientation θ is known, the subspace of potential sensor poses/locations of a point source is the space formed between hyperplanes going through the point source. In a two dimensional case, there are two hyperplanes/lines forming a triangle. If the orientation θ of the sensor is unknown, the solution space becomes three dimensional and the triangle rotates for changing orientations θ around the point s. In FIG. 5, the subspace 6.1 of the potential sensor poses of the point 5.1, the subspace 6.2 of the potential sensor poses of the point 5.2 and the subspace 6.3 of the potential sensor poses of the point 5.3 are shown. A similar equation system could be computed for a three dimensional scene with the solution space (tx, ty, tz, θ1, θ2). In the three dimensional case, four hyperplanes going through the location of the point source s form a rectangular cone. If the orientation(s) θ1 and/or θ2 of the sensor is/are unknown, the solution space increases by one or two dimensions and the cone rotates for changing orientations θ around the point s. Thus, depending on the dimensionality of the scene (2D or 3D) and how many of the sensor pose parameters are known, the solution space of potential sensor poses could have between 2 and 5 dimensions.

In a third step, the pose intersection region of the sub-spaces of potential poses corresponding to the point sources is calculated. In FIG. 5, the pose/location intersection region 7 is computed by intersecting the subspaces 6.1, 6.2 and 6.3. The pose intersection region 7 reduces the subspace of potential poses of the sensor.

In a fourth step, a point of said pose intersection region is selected as the estimated pose of the sensor having captured the image or of the estimated viewpoint of the image. As in the previous embodiment, the centre of mass 7′ of the pose intersection region could be used as estimator of the sensor pose. However also other points in the intersection region 7 could be used as estimator.

In a third embodiment, the locations of a plurality of point sources and/or the poses of different images of a set of images shall be determined on the basis of the set of images taken from different viewpoints or sensor poses.

In a first step a plurality of point sources in the images of the set of images are identified (or received). In one embodiment, each of the identified point sources is represented in each of the images. In another embodiment, at least some of the identified point sources might be present only in some of the set of images, because with different viewpoints new point sources are added to the images and some point sources are lost. In one embodiment, the subregion or pixel of the image related to a point source is identified.

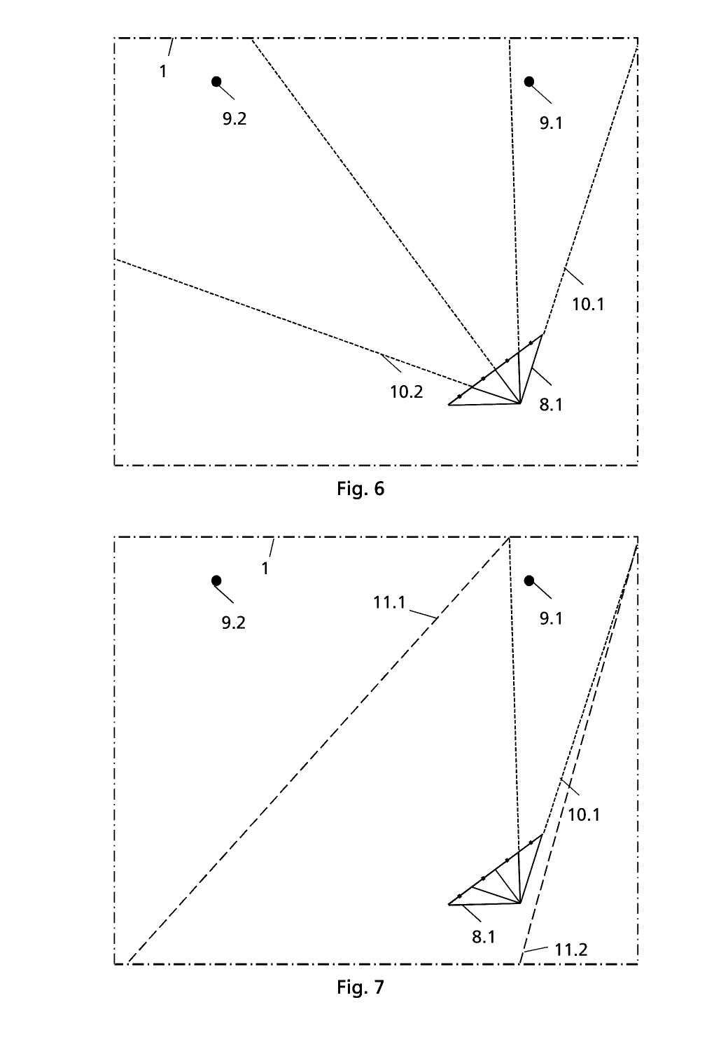

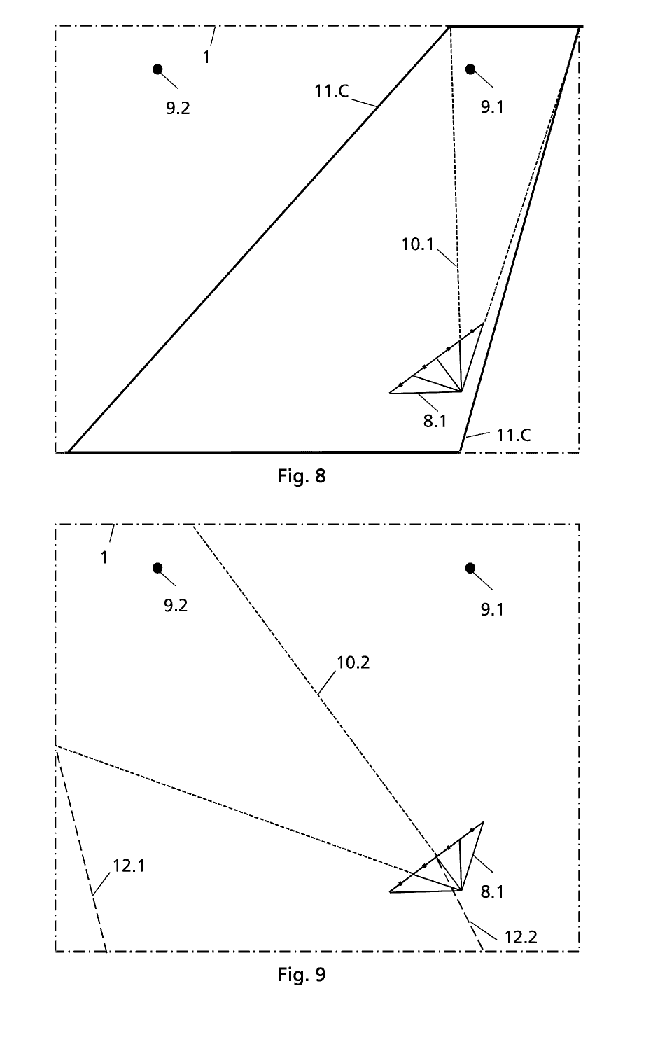

In a second step, for each point source of a first image of the set of images the sub-space of potential locations of the point source in the scene is computed on the basis of the sub-region of the image representing the point source. FIG. 6 shows an example of a first image taken from a first sensor pose 8.1 or viewpoint. In the first image two (any other number possible) point sources 9.1, 9.2 are identified. On the basis of the pixel area of the sensor 8.1 related to the point source 9.1, the subspace 10.1 of potential locations of the point source 9.1 is computed as described in the first embodiment. If the position of the sensor 8.1 in the scene is known, the absolute position of the subspace 10.1 in the scene 1 can be calculated. Otherwise all positions could be calculated at least relative to the pose of the sensor or the viewpoint of the first image. For example the origin of the coordinate system of the scene 1 could be defined on the basis of the location and/or orientation of the sensor having captured the first image.

The following steps are performed iteratively for each other image of the set of images, if there is more than one other image in the set of images. If the images are taken successively at different viewpoints, the steps could be performed in real time. The term “the other image” shall mean in the following the other image of the set of images presently treated in this iteration.

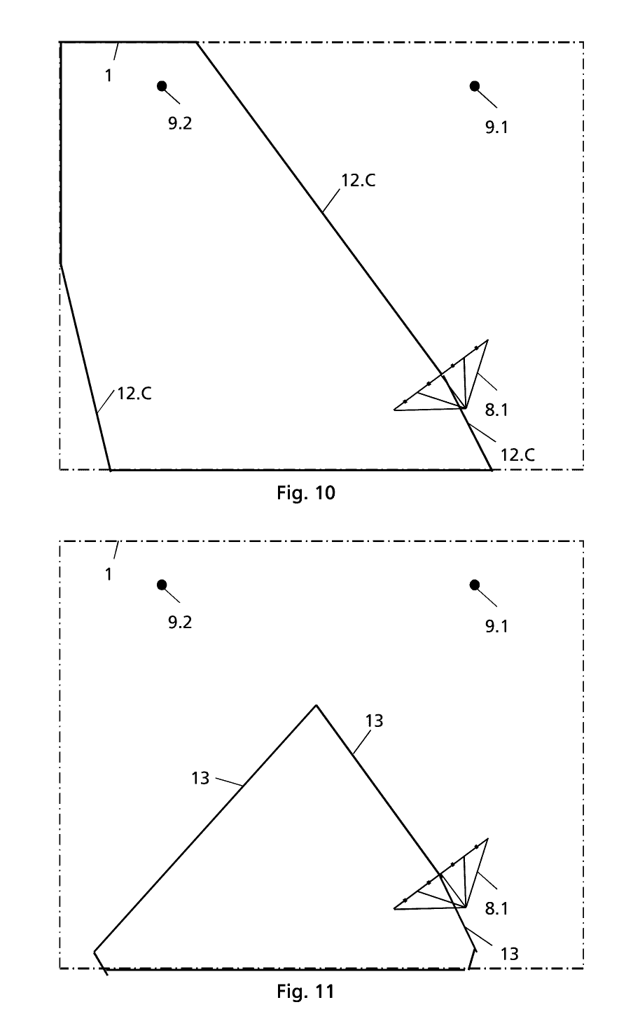

In a third step for each computed subspace of potential locations of the point sources (identified also in the other image) the subspace of potential poses of the sensor having captured the other image is computed on the basis of the previously computed subspace of the potential locations of the point source and the sub-region of the image representing the point source. In the second embodiment, it was described how the subspace of potential poses of the sensor can be calculated for a single known point. Since the subspace of potential locations of the point source is known, the subspace of potential poses of the sensor of the other image can be calculated from this subspace of potential locations of the point source and its subregion on the other image or its sensor. Preferably, this is achieved by computing first for each vertex (corner) or some of the vertices of the subspace of the potential locations of the point source the subspace of potential poses of the camera from the vertex. This is possible, because the subspace of potential locations of the point source is a convex polygon (or polyhedron for higher dimensional cases). FIG. 7 shows the subspace 10.1 of potential locations of point source 9.1 of example of FIG. 6. In one embodiment, the general subspace of potential poses of the sensor of the other image is computed based on the subspaces of potential poses of the sensor of the other image computed from the single vertices. If the subspaces of potential poses from the vertices are formed by hyperplanes, the hyperplanes can be distinguished by types (left and right line for 2D, first to fourth plane in 3D). For each type of hyperplane, the hyperplanes of the subspaces of potential poses from the vertices are combined. The combination is chosen such that the most points are included by the combined line/surface (hyper surface), i.e. the weakest combination. In the 2D case with known sensor orientation, first all the left border lines of the subspaces of the potential poses from the vertices are combined and then all the right border lines of the subspaces of the potential poses from the vertices are combined. Then, the general or combined subspace of potential poses of the sensor is computed as the space between the combined hyper surfaces of the different types of hyperplanes. In another embodiment, it is also possible to compute only the external hyperplanes of the subspaces of potential sensor poses of a subset of vertices which yield the largest combined subspace of potential sensor poses. FIG. 7 shows the two hyperplanes 11.1 and 11.2 yielding the largest subspace of potential sensor poses. Combining those two hyperplanes 11.1 and 11.2, i.e. taking the space between the two hyperplanes 11.1 and 11.2, yields the combined or general subspace of potential sensor poses for the subspace of potential locations of the point source 9.1. The same is done for the second point 9.2 as shown in FIGS. 9 and 10 resulting in combined subspace 12.C of potential sensor poses from the subspace 10.2 of potential locations of the point source 9.2.

In a fourth step, a sensor intersection region between the sub-spaces of potential poses of the sensor of the other image corresponding to the point sources is computed. This is achieved by intersecting the subspaces 11.C, 12.C of potential sensor poses for the computed point sources 9.1, 9.2 resulting in a sensor intersection region 13 shown in FIG. 11. If the number of point sources 9.1, 9.2 increases, the sensor intersection region 13 converts fast and reliable to the true pose of the sensor in which the other image was taken. In one embodiment, first all subspaces 11.C, 12C of potential sensor poses for all point sources are computed and then intersected. In another embodiment, the first calculated subspace 11.C of potential sensor poses could be used as sensor intersection region and each newly calculated subspace 12.C could be intersected with the previously calculated intersection region.

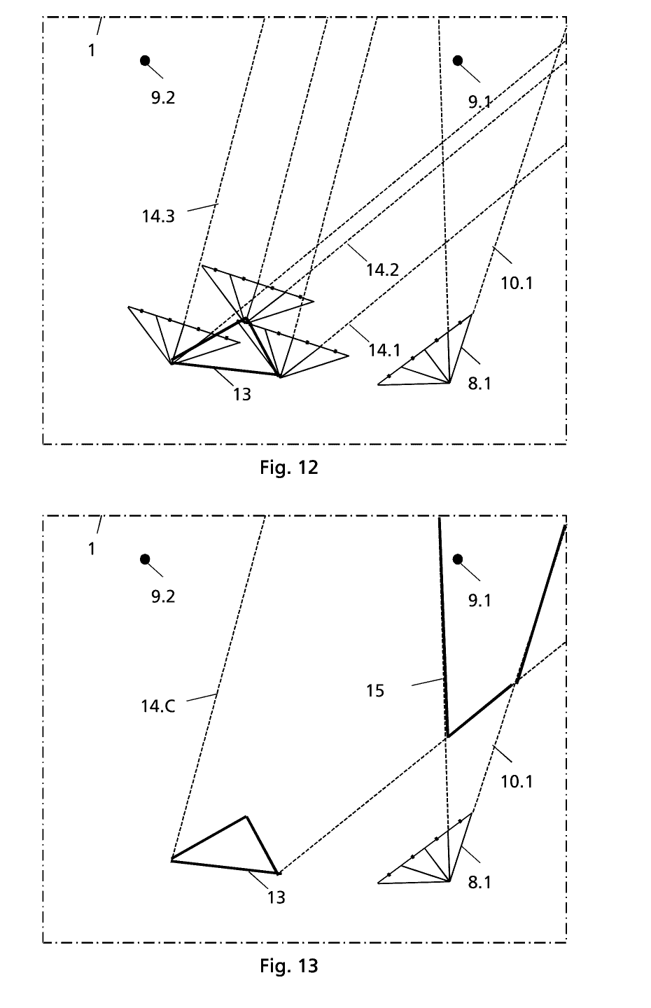

In a fifth step for each point source of the other image the sub-space of potential locations of the point source in the scene are calculated on the basis of the sub-region of the other image representing the point source and on the basis of the sensor intersection region of the sub-spaces of potential poses of the sensor of the other image. As described in the first embodiment, the subspace 10.1 of potential locations of a point source 9.1 could be improved by intersecting it with a subspace of potential locations of the point source 9.1 from a second image (here the other image) taken from another viewpoint. Contrary to the first embodiment, the exact viewpoint or sensor pose of the other image is not known. But the subspace of potential poses of the other image is known from the sensor intersection region 13 previously calculated. By calculating the subspaces of potential locations of the point 9.1 for all poses in the sensor intersection region 13 and combining them, the subspace of potential sensor poses for the point source 9.1 is achieved. Similar as in the third step, it is also sufficient to calculate in one embodiment the subspaces 14.1, 14.2, 14.3 of potential locations of the point source 9.1 from the vertices of the intersection region 13 and combining them to the subspace 14.C of potential locations for the point source 9.1 (see FIGS. 12 and 13). It is also possible to reduce further the computational burden by computing only the two (or some) most distant hyperplanes of two subspaces 14.1 and 14.3 of two (or some) of the vertices for finding the maximal subspace of potential. For sake of visibility, the sensor intersection region 13 in the FIGS. 12 and 13 has been selected smaller than in FIG. 11 as would be the case for a higher number of point sources. For the sake of visibility and without restriction of the invention, the orientation of the sensor was assumed to be known.

In a sixth step, for each point source 9.1, 9.2 as a new sub-space of potential locations of the point source 9.1 it is calculated the point intersection region 15 between the sub-space 14.C of potential locations of the point source 9.1 in the scene 1 of the other image and the previously computed sub-space 10.1 of potential locations of the point source 9.1 in the scene 1. The fifth step could be performed first for all point sources 9.1 and 9.2 and then the sixth step can be performed for all point sources 9.1 and 9.2. In an alternative embodiment, the fifth and sixth step could be performed successively for each point source 9.1 and 9.2 before the next point source 9.1 and 9.2 is treated.

The third to sixth step is repeated for all other images of the set of images and the sensor intersection regions and the point intersection regions convert quickly and reliably to the true sensor poses and the true point locations.

If the locations of the point sources 9.1 and 9.2 shall be estimated, a location of each point intersection region 15 is selected to estimate the location of each point source 9.1 and 9.2. E.g. the centre of mass of the point intersection region 15 could be a good estimator. Alternatively or in addition, if the poses of the sensors shall be estimated, a pose of each sensor intersection region 13 is selected to estimate the pose of each sensor. E.g. the centre of mass of the sensor intersection region 13 could be a good estimator.

An application of such a system is in an autonomous moving device, like autonomous cars, autonomous flying device (e.g. drones), robots, etc. Autonomous means here that moving device controls itself its movement. The processor to determine the point source location and the sensor pose could be arranged in the autonomous moving device or at a remote location connected to the autonomous moving device. The processor could calculate the location of the autonomous moving device on the basis of the sensor(s) in the moving device in real time and base the control of the movement of the car on its position relative to the identified point sources.

The geometrical operations like creating hyperplanes in a space, combining hyperplanes, intersecting subspaces, etc. can be performed on a processor by geometrical computing modules which are well known in the state of the art.

1. System comprising
at least one sensor configured to take a set of images from different viewpoints of a scene;
a processor configured to
identifying a point source represented in the images of a set of images;
computing for each image of the set of images the subspace of potential locations of the point source in the scene on the basis of the viewpoint or a viewpoint region of the image and on the basis of the subregion of the image representing the point source;
computing a point intersection region of the subspaces of potential locations of the point source of the images of the set of images.

2. System according to claim 1, wherein each of the at least one sensor has a plurality of pixel areas, wherein the sub-region of the image representing the point source corresponds to the pixel area representing the point source in the respective image.

3. System of claim 1, wherein each of the at least one sensor is camera and the subspace of potential locations for each image is calculated on the basis of hyperplanes going through the camera centre of the image and the boundaries of the sub-region of the image representing the point source.

4. System of claim 1, wherein the processor is configured to selecting a point of said point intersection region as the estimated location of the point source.

5. System of claim 4, wherein said selection of a point is made by calculating the centroid point of said point intersection region.

6. System according to claim 1,
wherein the step of identifying a point source represented in the images of the set of images comprises identifying a plurality of point sources in the images of the set of images;
wherein the steps of computing for each image of the set of images the sub-space of potential locations of the point source in the scene and computing a point intersection region comprise the steps of computing for each point source of a first image of the set of images the sub-space of potential locations of the point source in the scene on the basis of the sub-region of the image representing the point source and of performing for each other image of the set of images the following steps:
computing for each computed subspace of potential locations of the point sources identified in this other image the subspace of potential poses of the sensor having captured the other image on the basis of the previously computed subspace of the potential locations of the point source and the sub-region of the image representing the point source;
computing a sensor intersection region between the sub-spaces of potential poses of the sensor of the other image corresponding to the point sources;
computing for each point source of the other image the sub-space of potential locations of the point source in the other image on the basis of the sub-region of the other image representing the point source and on the basis of the sensor intersection region of the sub-spaces of potential poses of the sensor of the other image;
computing for each point source identified in the other image as a new sub-space of potential locations of the point source the point intersection region between the sub-space of potential locations of the point source in the scene of the other image and the previously computed sub-space(s) of potential locations of the point source in the scene.

7. System according to claim 6, wherein the processor is configured to selecting a point of each sensor intersection region as the estimated pose of the sensor of the corresponding image and/or selecting a point of each point intersection region as estimated location of the corresponding point source.

8. System according to claim 6, wherein the system comprises a moving device comprising the at least one sensor, wherein the system comprises a navigation system for navigating the moving device in the scene on the basis of the position of the moving device relative to the location of the point sources.

9. Non-transitory computer program configured to perform the following steps, when executed on a processor:
receiving or identifying a point source represented in images of a set of image, wherein the images are taken from different viewpoints of a scene;
computing, in the processor, for each image of the set of images the sub-space of potential locations of the point source in the scene on the basis of the viewpoint or a viewpoint region of the image and on the basis of the sub-region of the image representing the point source;
computing, in the processor, a point intersection region of the sub-spaces of potential locations of the point source of the images of the set of images.

10. Program of claim 9, wherein the sub-region of the image representing the point source corresponds to a pixel area representing the point source in the respective image.

11. Program of claim 9, wherein each of the at least one sensor is camera and the sub-space of potential locations for each image is calculated on the basis of hyperplanes going through the camera centre of the image and the boundaries of the sub-region of the image representing the point source.

12. Program of claim 9, wherein the processor is configured to selecting a point of said point intersection region as the estimated location of the point source.

13. Program of claim 12, wherein said selection of a point is made by calculating the centroid point of said point intersection region.

14. Program of claim 9, wherein the step of identifying a point source represented in the images of the set of images comprises identifying a plurality of point sources in the images of the set of images;
wherein the steps of computing for each image of the set of images the sub-space of potential locations of the point source in the scene and computing a point intersection region comprise the steps of computing for each point source of a first image of the set of images the sub-space of potential locations of the point source in the scene on the basis of the sub-region of the image representing the point source and of performing for each other image of the set of images the following steps:
computing for each computed subspace of potential locations of the point sources the subspace of potential poses of the sensor having captured the other image on the basis of the previously computed subspace of the potential locations of the point source and the sub-region of the image representing the point source;
computing a sensor intersection region between the sub-spaces of potential poses of the sensor of the other image corresponding to the point sources;
computing for each point source of the other image the sub-space of potential locations of the point source in the scene on the basis of the sub-region of the other image representing the point source and on the basis of the sensor intersection region of the sub-spaces of potential poses of the sensor of the other image;
computing for each point source as a new sub-space of potential locations of the point source the point intersection region between the sub-space of potential locations of the point source in the scene of the other image and the previously computed sub-space of potential locations of the point source in the scene.

15. Program of claim 14, comprising the step of selecting, in the processor, a point of each sensor intersection region as the estimated pose of the sensor of the corresponding image and/or selecting, in the processor, a point of each point intersection region as estimated location of the corresponding point source.

16. Non-transitory computer program for determining a pose of a sensor which captured an image of a scene, said computer program is configured to perform the following steps, when executed on a processor:
receiving or determining, in the processor, sub-regions of the image representing each a different point source;
receiving or determining, in the processor, the locations or location regions of the point sources represented in the sub-regions of the image;
computing, in the processor, for each point source the sub-space of potential poses of the sensor in the scene on the basis of the location or location region of the point source and on the basis of the sub-region of the image representing the point source;
computing, in the processor, the pose intersection region of the sub-spaces of potential poses corresponding to the point sources;
selecting a point of said pose intersection region as the estimated pose of the sensor.

17. Non-transitory computer program of claim 16, wherein said selection is made by calculating the centroid point of said pose intersection region.
